(19) United States
(12) Patent Application Publication
(10) Pub. No.: US 2025/0327536 A1
(43) Pub. Date: Oct. 23, 2025

(54) Faucet Raw Material Silicone Sleeve

(71) Applicant: Fan Jiang, Yueyang (CN)

(72) Inventor: Fan Jiang, Yueyang (CN)

(21) Appl. No.: 19/257,309

(22) Filed: Jul. 1, 2025

(51) Int. Cl. F16L 5/10

(52) U.S. Cl. CPC F16L 5/10

(57) ABSTRACT

A Faucet Raw Material Silicone Sleeve includes a faucet raw material silicone sleeve body, wherein thread grooves are arranged inside inner side of the faucet raw material silicone sleeve body, and the faucet raw material silicone sleeve body further includes a surface layer covered with an anti-microbial layer. A raised edge is provided on top-front edge of the faucet raw material silicone sleeve body, both the faucet raw material silicone sleeve body and the raised edge are integrally formed. When one needs to install a faucet with existing raw material belt, he/she must wrap the faucet thread to prevent water leakage and the wrapping process is annoying and requires experience, while the present disclosure makes faucet installation easy and quick, also prevents water dripping or leakage.

### TECHNICAL FIELD

The present disclosure relates to a technical field of faucet silicone raw material sleeve, particularly to a Faucet Raw Material Silicone Sleeve.

### BACKGROUND

Faucet silicone sleeve, an important accessory for faucet installation, has many advantages and functions. It effectively prevents water from dripping, keeps faucets dry and clean to avoid bacterial growth. With good wear resistance and high temperature resistance, silicone material sleeve prolongs useful life for a faucet in a good looking state. In addition, the silicone sleeve's softness and elasticity makes it convenient to install and replace.

Currently, the Chinese Utility Model Patent with the publication number CN206369003U discloses a set of inner pipe and outer ring sleeves for a faucet, which includes an outer ring sleeve and an inner pipe. The inner pipe is nested in the cavity of the outer ring sleeve. The outer ring sleeve is provided with a hollow cylinder with a middle window and a middle ring separation, and the inner pipe can rotate and slide in the hollow container chamber. This utility model patent provides a set of inner pipes and outer ring sleeve for a faucet with a metal inner pipe plus an outer ring sleeve. Moreover, its whole structure is simple but reliably durable, which ensures good sealing performance during a faucet installation and prolongs a faucet's service life.

If one installs a faucet, he/she needs raw material tape to wrap the connection of a faucet and the pipe. Wrapping with raw material tape not only requires a user with experience, but also annoys the user most of time, for when wrapping too many, one fails to install the faucet in the right position, and if the faucet is installed in the right position, water drips at the connection part. Moreover, raw material tapes will be shrinking as time goes by, and then it fails to fit tightly resulting in water leakage.

### SUMMARY

The present disclosure provides a Faucet Raw Material Silicone Sleeve, aimed at solving the troublesome and water leakage for raw material tapes. As is known, when one install faucets at home, he/she usually uses raw material tapes for wrapping the faucet connection part or the pipe connection part to make sure that the faucet and the pipe connected tightly without water dripping. If one wraps too many circles of raw material tape, then he/she fails to install the faucet to its right position, on the contrary, if he/she wraps too few circles, then he/she finds the faucet is dripping for the connection part is not tight.

The present disclosure provides a Faucet Raw Material Silicone Sleeve, including a faucet raw material silicone sleeve body, wherein thread grooves are arranged on inner side of the faucet raw material silicone sleeve body, and the faucet raw material silicone sleeve body further includes a surface layer covered with an anti-microbial layer; and a raised edge is provided on top-front edge of the faucet raw material silicone sleeve body.

In order to achieve the effect of determining the outer diameter of the raw material silicone sleeve body, preferably, the outer diameter of the raw material sleeve body is 24 millimeters, inner diameter is 17 millimeters, and the raised edge is 3.5 millimeters in width.

Further, the height of the raw material silicone sleeve body is 13 millimeters, and 1 millimeter in thickness.

In order to achieve a better anti-microbial effect, preferably, the raw material silicone sleeve body is silicone, and the anti-microbial layer is silver ion material.

Preferably, the sectional diameter of the raw material silicone sleeve body is 30 mm, and the opening of the raw material silicone sleeve body is round (2 π radian).

Compared with existing technologies, the beneficial effects of this utility are:

With a threaded groove provided on the inner wall of the raw material silicone sleeve body, users can easily have the raw material silicone sleeve body inserted and covered a faucet's connection part through the threaded groove, resulting in better wrapping performance; second, the raised edge on front side of the raw material sleeve body prevents the faucet from water leaking after installation; third, the anti-microbial layer better avoids attracting bacteria during useful life of the raw material silicone sleeve.

### BRIEF DESCRIPTION OF DRAWINGS

FIG. 1 shows the overall structure diagram of the Faucet Raw Material

Silicone Sleeve of this utility;

FIG. 2 shows a sectional view of the raw material sleeve body in this utility;

FIG. 3 shows the height of the raw material sleeve body in this utility;

FIG. 4 shows the structural diagram of the surface layer in this utility; and

FIG. 5 shows the overall structure diagram of the prior art CN206369003U.

In the figures, 1. raw material silicone sleeve body; 101. surface layer; 102. anti-microbial layer; 2. thread groove; 3. raised edge.

### DESCRIPTION OF EMBODIMENTS

In order to make the purpose, technical solution, and advantages of this utility patent clearer, the following is a further detailed explanation of this utility patent in conjunction with the accompanying drawings and embodiments. It should be understood that the specific embodiments described here are only intended to explain the present utility patent and are not intended to limit the present utility model.

It should be understood that the terms “length”, “width”, “upper”, “lower”, “front”, “rear”, “left”, “right”, “vertical”, “horizontal”, “top”, “bottom”, “inside”, “outside” and the like indicate orientations or positional relationships based on those shown in the figures, and are intended only to facilitate the description of the present disclosure and to simplify the description, and are not intended to indicate or imply that the device or element referred to must have a particular orientation, be constructed and operated in a particular orientation, and therefore are not to be construed as a limitation of the present disclosure. Furthermore, in some descriptions of the present disclosure, “more than one” means two or more, unless otherwise expressly and specifically limited.

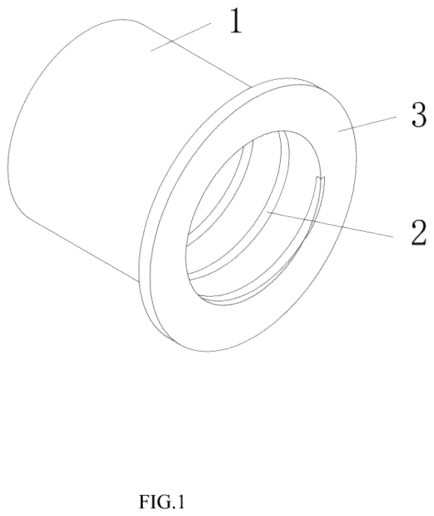

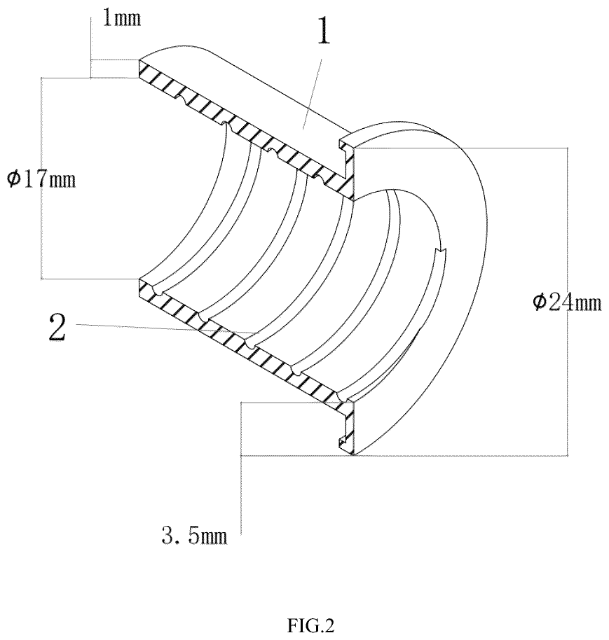

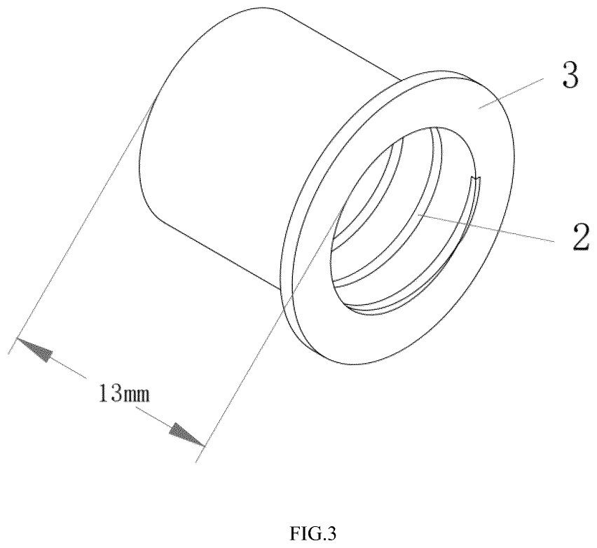

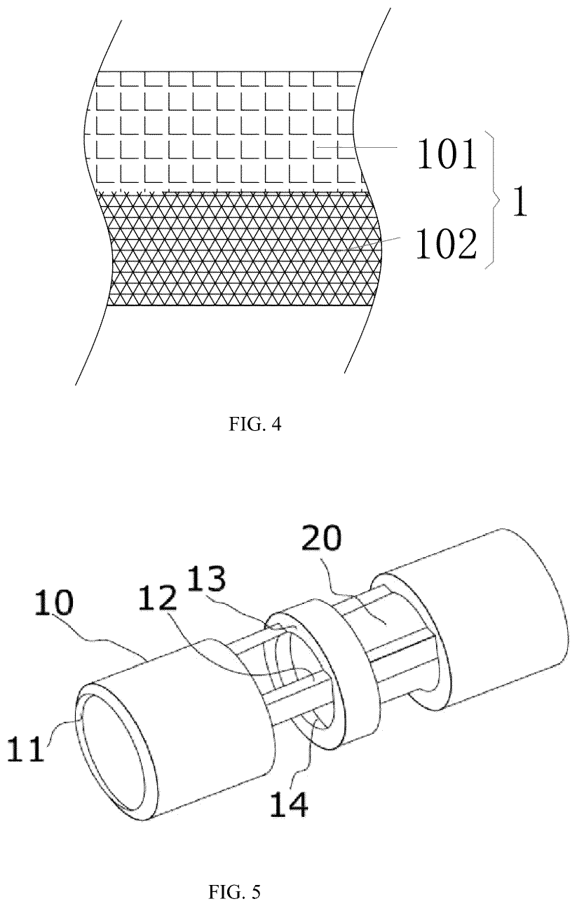

As shown in FIGS. 1-4, a Faucet Raw Material Silicone Sleeve, comprising a raw material silicone sleeve body 1, wherein inner wall of the raw material silicone sleeve body 1 is provided with threaded grooves 2. The raw material silicone sleeve body 1 further includes a surface layer 101 where is provided with anti-bacterial layer 102, and a raised edge 3 is provided on front side of the raw material silicone sleeve body 1, which is integrally formed with the raised edge 3.

In this embodiment, the raw material silicone sleeve comprises a raw material silicone sleeve body 1 wherein is provided with threaded grooves 2 on inner wall of the raw material sleeve body 1. Users have the raw material silicone sleeve body 1 inserted to wrap the faucet connection part and have a better wrapping performance with the threaded grooves 2. Besides, the raised edge 3 on the front side of the raw material silicone sleeve body 1 prevents the faucet from water leaking during installation and useful life. The anti-microbial layer 102 better avoids attracting bacteria in long-term use of the raw material silicone sleeve.

As a technical optimization solution, the raw material sleeve body 1 is 13 millimeters in height, and 1 millimeter in thickness.

In this embodiment, the raw material sleeve body 1 is in shape of column with a raised edge on a top side and an opening in a circle on a bottom side, wherein outer dimension of the raw material sleeve body 1 is 24 millimeter, inner diameter of the raw material sleeve body is 17 millimeter, and the width of the raised edge is 3.5 millimeter, with the elasticity of silicone material, the raw material silicone sleeve is suitable for various types of faucets.

As a technical optimization solution, the raw material silicone sleeve body 1 is made of silicone, and the anti-microbial layer 102 is of silver ion material.

In this embodiment, the raw material silicone sleeve body 1 has features, including better anti-freeze, anti-crack performance, environmentally friendly and pollution-free, and high temperature resistance and good elasticity. Further, the anti-microbial layer 102 is made of silver ion material, which is conducive to enhancing the anti-microbial effect of the raw material silicone sleeve body 1 and improving the durability of the raw material silicone sleeve.

In this embodiment, the round shape opening and elasticity of silicone make the raw material silicone sleeve suitable for various types of water pipes and faucets.

Working principle: threaded grooves 2 are provided on inner wall of the raw material silicone sleeve body 1, users have the raw material silicone sleeve body 1 easily covered the faucet connection part and wrapped, and the raised edge 3 on front side of the raw material silicone sleeve body 1 better prevents the faucet from water dripping in process of using. The anti-microbial layer is made of silver ion material, which has an effect of avoiding bacteria in the long-term use of the raw material silicone sleeve. The raw material silicone sleeve has features, including better anti-freeze, anti-crack performance, environmentally friendly and pollution-free, and high temperature resistance and good elasticity.

The above are only preferred embodiments of this utility patent and are not intended to limit it. Any modifications, equivalent replacements, and improvements made within the spirit and principles of this utility model should be included within the scope of protection of this utility patent.

1. A Faucet Raw Material Silicone Sleeve, comprising: a faucet raw material silicone sleeve body; wherein thread grooves are arranged inside inner side of the faucet raw material silicone sleeve body, and the faucet raw material silicone sleeve body further includes a surface layer covered with an anti-microbial layer;
a raised edge is provided on top-front edge of the faucet raw material silicone sleeve body, and the faucet raw material silicone sleeve body and the raised edge are integrally formed.

2. The Faucet Raw Material Silicone Sleeve according to claim 1, wherein the raw material sleeve body is 13 millimeters in height, and 1 millimeter in thickness.

3. The Faucet Raw Material Silicone Sleeve according to claim 1, wherein outer diameter of the raw material silicone sleeve body is 24 millimeters, inner diameter of the raw material sleeve body is 17 millimeters, and the width of the raised edge is 3.5 millimeters.

4. The Faucet Raw Material Silicone Sleeve according to claim 1, wherein the raw material silicone sleeve body is made of silicone, and the anti-microbial layer is of silver ion material.

5. The Faucet Raw Material Silicone Sleeve according to claim 1, wherein the raw material silicone sleeve body's opening is in a circle.
